(19) United States
(12) Patent Application Publication
(10) Pub. No.: US 2025/0377541 A1
(43) Pub. Date: Dec. 11, 2025

(54) EYEWEAR DISPLAY ALIGNMENT AND INTENSITY MONITORING USING CONVERTED LIGHT

(71) Applicant: GOOGLE LLC, Mountain View, CA (US)

(72) Inventor: Daniel Adema, Kitchener (CA)

(21) Appl. No.: 18/878,546

(22) PCT Filed: Jun. 26, 2023
(86) PCT No.: PCT/US2023/026245

§ 371 Date: Dec. 23, 2024

Related U.S. Application Data
(60) Provisional application No. 63/357,478, filed on Jun. 30, 2022.

(51) Int. Cl. G02B 27/01

(52) U.S. Cl. CPC G02B 27/0172; G02B 27/0179; G02B 2027/0178

(57) ABSTRACT

An eyewear display includes an optical engine to emit display light having one or more wavelengths in the visible light range. The eyewear display includes a waveguide to incouple a first portion of the display light, the first portion of the display light including light having the one or more wavelengths in the visible light range. The eyewear display also includes light conversion components positioned between the optical engine and the waveguide, the light conversion components to convert a second portion of the display light to generate converted light having higher wavelengths than the display light. In addition, the eyewear display includes a sensor to detect the converted light and a controller to modify the emission of display light from the optical engine based on the detected converted light.

### BACKGROUND

In an augment reality (AR) or mixed reality (MR) eyewear display, light from an optical engine is coupled into a light guide substrate, generally referred to as a waveguide or a lightguide, by an input optical coupling (i.e., an “incoupler) which can be formed on a surface of the substrate or disposed within the substrate. Once the light beams have been coupled into the waveguide, the light beams are “guided” through the substrate, typically by multiple instances of total internal reflection (TIR), to then be directed out of the waveguide by an output optical coupling (i.e., an “outcoupler”). The light beams projected from the waveguide by the outcoupler overlap at an eye relief distance from the waveguide forming an exit pupil within which a virtual image generated by the optical engine can be viewed by the user of the eyewear display. In AR/MR configurations, the eyewear display typically includes lenses that are transparent enough to allow ambient light from the user's environment to pass through. In this manner, the eyewear display provides the user with a visual experience that enhances the real world with the generated virtual image.

In some cases, the intensity of the display light emitted from the optical engine diminishes over time or the alignment of the optical engine with respect to a downstream component such as the incoupler shifts. This affects the quality of the virtual image delivered to the user of the eyewear display.

### SUMMARY

Various embodiments provide techniques to monitor the intensity of the display light emitted from an optical engine in an eyewear display as well as techniques to monitor the alignment of the optical engine with respect to a downstream optical component such as an incoupler. Based on this monitoring, a control signal is generated to control the optical engine to modify the emission of display light.

In a first embodiment, an eyewear display includes an optical engine to emit display light having one or more wavelengths and a waveguide to incouple a first portion of the display light. The first portion of the display light includes light having the one or more wavelengths. The eyewear display also includes a plurality of light conversion components positioned between the optical engine and the waveguide. The plurality of light conversion components converts a second portion of the display light to converted light having higher wavelengths than the display light.

In some aspects of the first embodiment, the eyewear display includes one or more sensors configured to detect the converted light to generate converted light data. In some aspects of the first embodiment, the eyewear display includes one or more filter layers to transmit the one or more wavelengths of display light emitted from the optical engine and reflect the converted light. In some aspects, the one or more filter layers direct the converted light to the one or more sensors. In some aspects of the first embodiment, the one or more filter layers include an opening aligned with a corresponding position of the one or more sensors. In some aspects of the first embodiment, the eyewear display includes an adhesive bridge between the one or more filter layers and the one or more sensors, the adhesive bridge having a refractive index to couple the converted light from one side of the one or more filter layers to the one or more sensors.

In some aspects of the first embodiment, the eyewear display includes a controller to receive the converted light data and generate a control signal for the optical engine based on the received converted light data. In some aspects, the control signal controls the optical engine to modify an intensity or a direction of the emitted display light. In some aspects of the first embodiment. the plurality of light conversion elements is positioned in a pattern between the optical engine and the waveguide to generate a converted light pattern. In some aspects, the one or more sensors detect the converted light pattern and generates light pattern data, and the controller receives the light pattern data and generates an alignment signal based on comparing the light pattern data to an expected light pattern. In some aspects, the alignment signal controls the optical engine to emit the display light in a different direction.

In some aspects of the first embodiment, the plurality of light conversion components includes one or more phosphors, one or more quantum dots, or a combination thereof.

In a second embodiment, an image projection system includes an optical engine to emit display light having one or more wavelengths and a waveguide to incouple a first portion of the display light. The first portion of the display light includes light having the one or more wavelengths. The image projection system also includes a plurality of light conversion components positioned between the optical engine and the waveguide. The plurality of light conversion components converts a second portion of the display light to converted light having higher wavelengths than the display light.

In some aspects of the second embodiment, the image projection system includes one or more sensors configured to detect the converted light to generate converted light data. In some aspects of the second embodiment, the image projection system includes a controller to receive the converted light data and generate a control signal for the optical engine based on the received converted light data.

In a third embodiment, a method includes emitting, by an optical engine, display light having one or more wavelengths. The method also includes incoupling, at a waveguide, a first portion of the display light, the first portion of the display light including light having the one or more wavelengths. The method further includes converting, by a plurality of light conversion components positioned between the optical engine and the waveguide, a second portion of the display light to converted light having higher wavelengths than the display light. Additionally, the method includes detecting, by one or more sensors, the converted light.

In some aspects of the third embodiment, the method includes generating converted light data based on the detected converted light. In some aspects of the third embodiment, the method further includes generating, based on the converted light data, a control signal to control one or more parameters of the display light emitted by the optical engine. For example, in some aspects, the one or more parameters include an intensity of the display light emitted by the optical engine or a direction of the display light emitted by the optical engine.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example eyewear display in accordance with some embodiments.

FIG. 2 shows an example of a projection system with a diffractive element arranged between the light engine and incouplers of a waveguide of an eyewear display, such as that shown in FIG. 1, in accordance with some embodiments.

FIG. 3 shows an example display light monitoring and optical engine control system to monitor and control the emission of light from an optical engine, such as the one shown in FIG. 2, in accordance with some embodiments.

FIGS. 4-6 show examples of display light monitoring and optical engine control system with converted light directing components to direct the converted light to a sensor, in accordance with some embodiments.

FIG. 7 shows an example of a display light and alignment monitoring optical engine control system, in accordance with various embodiments.

FIGS. 8 and 9 show example patterns of light conversion components arranged over an optical engine in the form of a microLED display panel, in accordance with various embodiments.

FIG. 10 shows an example of filter layers positioned around an incoupler for alignment monitoring, in accordance with various embodiments.

FIG. 11 shows an example incoupler and filter layer configuration for alignment monitoring, in accordance with various embodiments.

FIG. 12 shows an example of a flowchart describing a method for monitoring display light emitted from an optical engine, in accordance with various embodiments.

### DETAILED DESCRIPTION

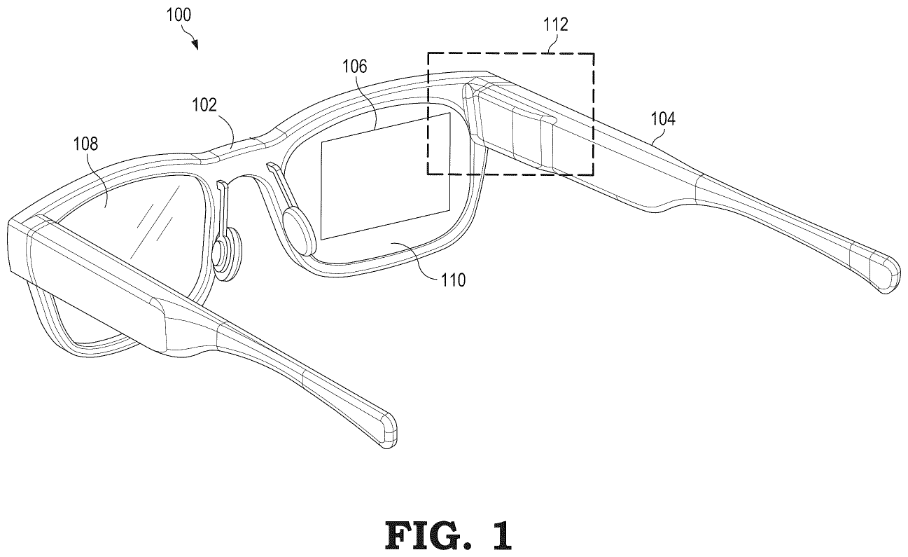

An eyewear display includes a series of components configured to generate the virtual image to be perceived by the user of the eyewear display. This series of components includes an optical engine that generates the display light to form the virtual image and a waveguide that is integrated into one or more lenses of the eyewear display for propagating the display light from the optical engine to the user. In some cases, the intensity of the display light emitted from the optical engine diminishes over time or the alignment of the components in the eyewear display shifts. For example, the optical engine emits the display light at a lower intensity as its light sources become older or the alignment of the incoupler with respect to the optical engine shifts due to vibrations from normal usage of the eyewear device (e.g., vibrations due to a user walking or running while wearing the eyewear display) or drop events. This affects the quality of the virtual image delivered to the user. FIGS. 1-12 provide techniques to monitor the intensity of the display light emitted from the optical engine as well as techniques to monitor the alignment of the optical engine with respect to a downstream optical component such as an incoupler. Based on data generated as a result of this monitoring, a processing component in the eyewear display generates a signal to control the intensity or direction of the display light emitted by the optical engine, thereby ensuring that the eyewear display continues to deliver quality images to the user.

To illustrate, an eyewear display includes an optical engine such as a microLED display to emit display light having one or more wavelengths such as red, blue, and green light wavelengths in the visible light spectrum. The eyewear display also includes a waveguide with an incoupler to incouple a first portion of the display light emitted from the optical engine. The eyewear display further includes a plurality of light conversion components positioned between the optical engine and the waveguide. For example, the plurality of light conversion components includes phosphors or quantum dots integrated into a cover glass over the optical engine. The plurality of light conversion components converts a second portion of the display light emitted from the optical engine to generate converted light having longer wavelengths than the display light. In some cases, the converted light is infrared (IR) light that is not perceivable by a user and the second portion of display light that is converted is a minimal amount so as not to materially affect the quality of the image delivered to the user. In some embodiments, the eyewear display also includes a sensor and a controller. The sensor detects the converted light to generate converted light data. The controller receives the converted light data and generates a control signal for the optical engine based on the converted light data. The control signal controls the optical engine to increase the intensity of the display light or change the direction in which the display light is emitted. Thus, based on monitoring the converted light data, the eyewear display is able to control the intensity and direction of the display light emitted from the optical engine in real-time to continue to deliver a quality virtual image to the user.

FIGS. 1-12 illustrate techniques to monitor the intensity of the display light emitted from the optical engine and techniques to monitor the alignment of the optical engine with respect to a downstream optical component in an eyewear display. Based on the data generated from this monitoring, a control signal is generated to control the emission of display light from the optical engine. As such, the techniques described herein provide a mechanism to control the display light emitted from the optical engine of the eyewear display to ensure that the eyewear display continues to deliver quality images to the user. However, it will be appreciated that the apparatuses and techniques of the present disclosure are not limited to implementation in this particular display system or method, but instead may be implemented in any of a variety of display systems using the guidelines provided herein.

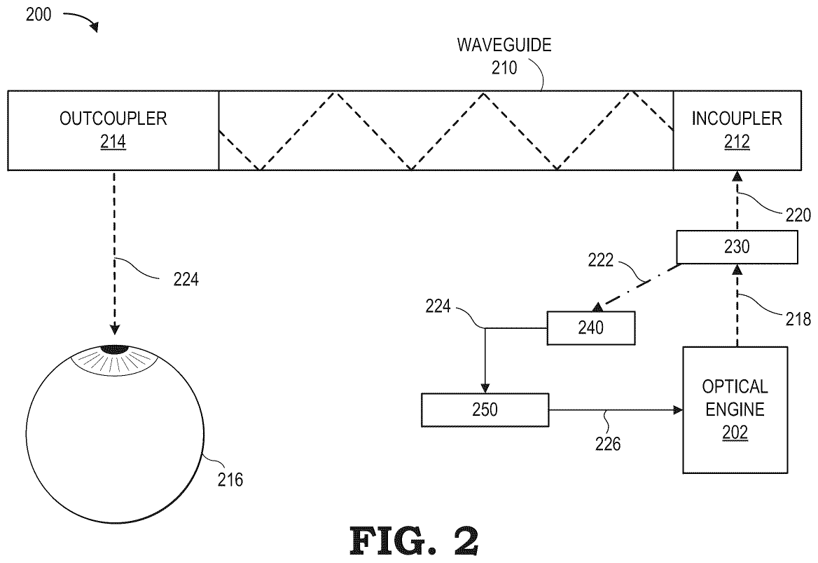

FIG. 1 illustrates an example eyewear display 100 in accordance with various embodiments. The eyewear display 100 (also referred to as a wearable heads up display (WHUD), head-mounted display (HMD), near-eye display, or the like) has a support structure, or frame, 102 that includes an arm 104 which houses a micro-display projection system configured to project images toward the eye of a user such that the user perceives the projected images as being displayed in a field of view (FOV) area 106 of a display at one or both of lens elements 108, 110 (only one FOV area 106 shown and labeled for clarity purposes). In the depicted embodiment, the frame 102 of the eyewear display 100 is configured to be worn on the head of a user and has a general shape and appearance (i.e., “form factor”) of an eyeglasses frame. The frame 102 contains or otherwise includes various components to facilitate the projection of such images toward the eye of the user, such as an optical engine (also referred to as light engine, image source, projector, or the like) and a waveguide (shown in FIG. 2, for example). In some embodiments, the frame 102 further includes various sensors, such as one or more front-facing cameras, rear-facing cameras, other light sensors, motion sensors, accelerometers, and the like. The frame 102 further can include one or more radio frequency (RF) interfaces or other wireless interfaces, such as a Bluetooth™ interface, a WiFi interface, and the like. The frame 102, in some embodiments, further includes processing circuitry or control circuitry to carry out functions of the eyewear display 100 such as monitoring the intensity of the display light emitted from the optical engine as well as monitoring the alignment between the optical engine and downstream optical components, for example. Further, in some embodiments, the frame 102 includes one or more batteries or other portable power sources for supplying power to the electrical components of the eyewear display 100. In some embodiments, some or all of these components of the eyewear display 100 are fully or partially contained within an inner volume of frame 102, such as within the arm 104 in a temple region 112 of the frame 102 or in a nose bridge region between the two lens rims of the frame 102. It should be noted that while an example form factor is depicted, it will be appreciated that in other embodiments the eyewear display 100 may have a different shape and appearance from the eyeglasses frame depicted in FIG. 1.

One or both of the lens elements 108, 110 are used by the eyewear display 100 to provide an AR or MR display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from an optical engine in the eyewear display 100. For example, light used to form a perceptible image or series of images may be projected by the optical engine of the eyewear display 100 onto the eye of the user via a series of optical elements, such as a waveguide formed at least partially in the corresponding lens element, one or more scan mirrors, one or more optical relays, and/or one or more prisms. One or both of the lens elements 108, 110 thus includes at least a portion of a waveguide that routes display light received by the incoupler to the outcoupler, which outputs the display light toward an eye of a user of the eyewear display 100. The display light is modulated and projected onto the eye of the user such that the user perceives the display light as an image in the FOV area 106. In addition, each of the lens elements 108, 110 is sufficiently transparent to allow a user to see through the lens elements to provide a field of view of the user's real-world environment such that the image appears superimposed over at least a portion of the real-world environment.

In some embodiments, the optical engine in the eyewear display 100 is a microLED panel, matrix-based projector, a scanning laser projector, or any combination of a modulative light source such as a laser or one or more LEDs and a dynamic reflector mechanism such as one or more dynamic scanners or digital light processors. In some embodiments, the optical engine includes multiple light emitting diodes (LEDs) or one or more laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The optical engine is communicatively coupled to a controller and a non-transitory processor-readable storage medium or memory storing processor-executable instructions and other data that, when executed by the controller, cause the controller to control the operation of the optical engine. In some embodiments, the controller controls a scan area size and scan area location for the image source and is communicatively coupled to a processor (not shown) that generates content to be displayed at the eyewear display 100. The image source scans light over a variable area, designated the FOV area 106, of the eyewear display 100. The scan area size corresponds to the size of the FOV area 106, and the scan area location corresponds to a region of one of the lens elements 108, 110 at which the FOV area 106 is visible to the user. Generally, it is desirable for a display to have a wide FOV area to accommodate the outcoupling of light across a wide range of angles. Herein, the range of different user eye positions that will be able to see the display is referred to as the eyebox of the eyewear display 100.

In some embodiments, the eyewear display 100 includes a plurality of light conversion components such as quantum dots or phosphors arranged between a waveguide incorporated into one of the lens elements 108, 110 and the optical engine of the eyewear display 100. The optical engine emits light in the visible spectrum (e.g., red, green, and blue (RGB) light) and the light conversion components absorb a small portion of the display light and convert it to a non-visible wavelength of light such as infrared (IR) or near-IR (NIR) light. That is, the light conversion components are positioned in the optical path of display light between the optical engine and the incoupler of the waveguide and convert a small percentage of the emitted display light (e.g., less than 10%, less than 5%, or less than 2%) to a light outside of the visible spectrum. The eyewear display 100 also includes a sensor with a detection sensitivity in the converted wavelength range (e.g., an IR sensor) that detects the converted light and generates converted light data based on the detected light. The eyewear display 100 also includes a controller coupled to the sensor to generate a control signal for the optical engine based on the converted light data. For example, if the converted light data indicates that the intensity of light emitted from the optical engine is below a threshold, the controller generates a control signal that controls the optical engine to increase the intensity (i.e., the power) of light emitted from the optical engine. As another example, if the converted light data indicates that the light emitted from the optical engine has shifted directions with respect to a downstream optical component such as an incoupler, the controller generates a control signal that controls the optical engine to shift the direction of the light it emits. Thus, the converted light is used to generate a feedback signal that the eyewear display 100 utilizes to control the intensity and the direction of light emitted from the optical engine. This feedback allows for better control of the display light emitted by the optical engine, thereby improving the performance of the eyewear display 100.

FIG. 2 illustrates an example diagram of a projection system 200 that projects images directly onto the eye 216 of a user of an eyewear display, in accordance with various embodiments. In some embodiments, the projection system 200 is implemented in an eyewear display, such as eyewear display 100 of FIG. 1, and includes an optical engine 202, a waveguide 210, a light conversion component layer 230, a sensor 240, and a controller 250. Although not illustrated in FIG. 2 for clarity purposes, in some embodiments, the projection system 200 includes an optical scanner with one or more scan mirrors, optical relays, lenses, or other projection optics between the optical engine 202 and the waveguide 210.

The optical engine 202 includes one or more light sources configured to generate and output display light 218 (e.g., visible light such as red, blue, and green (RGB) light). In some embodiments, the optical engine 202 is coupled to a driver or controller such as controller 250, which controls the timing and intensity of emission of light from the light sources of the optical engine 202 (e.g., in accordance with instructions received by the controller or driver from a computer processor coupled thereto) to modulate the display light 218 to be perceived as images when output to the retina of the eye 216 of the user. For example, during operation of the projection system 200, one or more beams of display light 218 are output by the light source(s) of the optical engine 202 and then directed into the waveguide 210 before being ejected from the waveguide as light 224 directed to the eye 216 of the user. The optical engine 202 modulates the respective intensities of the light beams so that the combined light reflects a series of pixels of an image, with the particular intensity of each light beam at any given point in time contributing to the amount of corresponding color content and brightness in the pixel being represented by the combined light at that time. In some embodiments, the optical engine 202 is a microLED display panel including a plurality of microLED sources that are each configured to emit light of a particular wavelength or color. The microLED display panel, in some embodiments, is implemented as an array of microscopic light emitting diodes (LEDs) on a common substrate.

In some embodiments, the optical engine 202 projects the display light 218 to a waveguide 210 of the projection system 200. The waveguide 210 includes the incoupler 212 and the outcoupler 214. The term “waveguide,” as used herein, will be understood to mean a combiner using total internal reflection (TIR), or via a combination of TIR, specialized filters, and/or reflective surfaces, to transfer light from an incoupler to an outcoupler. For display applications, the light may be a collimated image, and the waveguide transfers and replicates the collimated image to the eye. In general, the terms “incoupler” and “outcoupler” will be understood to refer to any type of optical grating structure, including, but not limited to, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In some embodiments, the incoupler includes one or more facets or reflective surfaces. For example, in some embodiments, the facets or reflective surfaces are selectively reflective depending on a color, wavelength, or polarization of light. In some embodiments, a given incoupler or outcoupler is configured as a transmissive diffraction grating that causes the incoupler or outcoupler to transmit light and to apply designed optical function(s) to the light during the transmission. In some embodiments, a given incoupler or outcoupler is a reflective diffraction grating that causes the incoupler or outcoupler to reflect light and to apply designed optical function(s) to the light during the reflection. In the present example, the display light 218 received at the incoupler 212 is relayed to the outcoupler 214 via the waveguide 210 using TIR. A portion of the display light 218 is then output to the eye 216 of a user via the outcoupler 214 as output light 224. Also, in some embodiments, an exit pupil expander (not shown), such as a fold grating, is arranged in an intermediate stage between the incoupler 212 and the outcoupler 214 to receive light that is coupled into waveguide 210 by the incoupler 212, expand the light in one dimension, and redirect the light towards the outcoupler 214. The display light 218 is then output as light 224 to the eye 216 of a user via the outcoupler 214. For example, in some embodiments, the outcoupler 214 is aligned with or sufficiently corresponds to the FOV area 106 illustrated in FIG. 1.

In some embodiments, the waveguide 210 is included in a lens stack between a world-side lens and an eye-side lens, which form lens elements 108, 110 shown in FIG. 1, for example. In some embodiments, the incoupler 212 and the outcoupler 214 are located, at least partially, at or near a common major surface of the waveguide 210. In another embodiment, the incoupler 212 and the outcoupler 214 are located on opposing major surfaces of the waveguide 210.

In some embodiments, the projection system 200 includes a light conversion component layer 230 positioned in the optical path between the optical engine 202 and the incoupler 212. In some embodiments, the light conversion component layer 230 is integrated into the optical engine 202 such as being integrated into a cover over the light emitting components of the optical engine 202. For example, in the case where the optical engine 202 is a microLED display, the light conversion component layer 230, in some embodiments, is integrated into a cover layer or film over the microLED display. In other embodiments, the light conversion layer 230 is integrated into a separate layer such as a glass, plastic, or other optically transparent sheet arranged between the optical engine 202 and the incoupler 212. The light conversion component layer 230 includes a plurality of light conversion elements. In some embodiments, the light conversion elements are quantum dots, phosphors, or other light converting elements that absorb light of a first wavelength range and emit light in a different wavelength range. For example, the light conversion elements absorb light of the visible light range emitted from the optical engine 202 and emit light of a non-visible light range such as infrared (IR) or near-IR light. That is, the light conversion elements are selected such that they emit light that is outside of the visible spectrum of what a user would be able to detect. In some embodiments, the light conversion elements are selected to emit light in the range of at least 700 nm or more, e.g., at least 800 nm. For example, the light conversion elements absorb light in the visible spectrum and emit IR light of about 840 nm. Thus, the light emitted from the light conversion elements in the light conversion layer 830 is not visible to the human eye and, accordingly, does not degrade the image displayed to the user.

In some embodiments, the light conversion layer 230 receives the display light 218 emitted from the optical engine 202 and allows a first portion 220 of the display light to pass through unaffected to the incoupler 212. That is, the light in the first portion 220 has the same wavelength as the display light 218 emitted from the optical engine 202. The light conversion layer 230 also absorbs a second portion of the light emitted from the optical engine 202 and converts it to light of a higher wavelength 222. That is, the light conversion components (e.g., the quantum dots or the phosphors) in the light conversion layer 230 absorb some of the visible display light 218 emitted from the optical engine 202 and emit it as non-visible light 222. In some embodiments, the amount of display light 218 that is converted to converted light 222 is in the range of 1%-10%. That is, 10% or less of the display light 218 that is emitted from the optical engine is converted to converted light 222 while 90% or more of the display light 218 is transmitted through the light conversion layer 230 as light 220. Thus, in some embodiments, the light conversion elements are sparsely spread out in the light conversion layer 230 such that the amount of display light 218 converted to converted light 222 does not have or has a minimal impact on the quality of the image delivered to the eye 216 of the user (i.e., the quantity of the light conversion components in the light conversion layer 230 is selected so as to have an imperceptible effect on the image as perceived by the user). The amount of converted light 222 is proportional to the display light 218 and, thus, may be used as a display feedback for controlling the optical engine 202.

In some embodiments, the projection system 200 includes a sensor 240 with a

detection sensitivity (e.g., is photosensitive) for light having the wavelength range of the converted light 222. For example, in the case where the light conversion elements in the light conversion layer 230 convert light from the visible spectrum to IR light, the sensor 240 is an IR sensor. In some embodiments, the sensor 240 is insensitive to light having a wavelength of the display light 218 emitted from the optical engine. For example, the sensor 240 has a detection sensitivity for IR light or near-IR light but is insensitive to the RGB display light emitted from the optical engine 202. As such, the sensor 240 is configured to detect the converted light 222 and generate converted light data 224 to transmit to the controller 250.

The controller 250 receives the converted light data 224 from the sensor 240 and uses this data to generate a control signal 226 to control the optical engine 202. In some embodiments, the control signal 226 is a voltage signal that controls the optical engine 202 to increase or decrease the intensity of the emitted display light 218 or controls the optical engine 202 to modify the direction of the emitted display light 218. To illustrate, in a first example, the controller 250 receives the converted light data 224 and determines, from the converted light data 224, that the intensity of the display light 218 has fallen below an intensity threshold. Accordingly, the controller 250 generates the control signal 226 to control the optical engine 202 to increase the intensity of the emitted display light 218. In some embodiments, the control signal 226 controls the optical engine 202 to increase the power the optical engine 202 delivers to its light sources, which in turn increases the intensity of the display light 218. In another example, the controller 250 receives the light data 224 and determines that the alignment of the display light 218 emitted from the optical engine 202 has shifted with respect to a downstream component such as the incoupler 212. For example, in some embodiments, the light conversion elements in the light conversion layer 230 are positioned in a particular pattern, and the sensor 240 is configured to detect shifts in the pattern. Accordingly, the controller 250 generates a control signal 226 that controls the optical engine 202 to modify the direction of the emitted display light 218. In sum, the controller 250 is configured to receive the converted light data 224 from the sensor 240 and determine, based on the converted light data 224, whether to generate a control signal 226 to instruct the optical engine 202 to modify the output of the display light 218. In some embodiments, the controller 250 is implemented as one of software executing on a processor, hardware that is hard-wired (e.g., circuitry) to perform the various operations described herein, or a combination thereof.

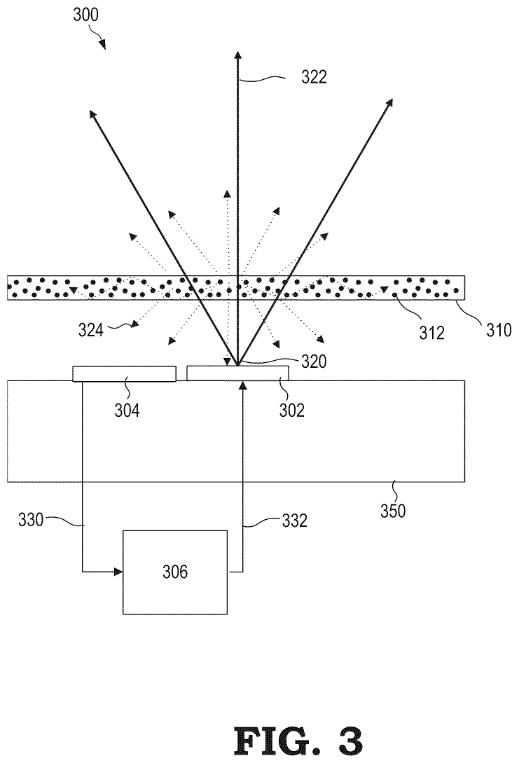

FIG. 3 illustrates an example display light monitoring and optical engine control system 300 in accordance with various embodiments. The display light monitoring and control system 300 includes an optical engine 302 such as a microLED display, a sensor 304, a controller 306, and a light conversion component layer 310. In some embodiments, the optical engine 302 corresponds to the optical engine 202 of FIG. 2, the sensor 304 corresponds to the sensor 240 of FIG. 2, the controller 306 corresponds to the controller 250 of FIG. 2, and the light conversion component layer 310 corresponds to the light conversion component layer 230 of FIG. 2. Accordingly, in some embodiments, the display light monitoring and optical engine control system 300 shown in FIG. 3 is implemented in an eyewear display such as the eyewear display 100 of FIG. 1.

As illustrated in FIG. 3, in some embodiments, the optical engine 302 and the sensor 304 are positioned on a common substrate 350. In some configurations, the optical engine 302 is a microLED panel with an array of microLEDs arranged on the substrate 350 with one or more sensors 304 positioned adjacent to the array of microLEDs. The optical engine 302 emits display light 320 (only one arrow labeled for clarity purposes) illustrated as solid lines. The display light 320, for example, is visible light such as red, green, blue (RGB) light that is used to generate virtual images perceived by a user of an eyewear display (e.g., an eyewear display corresponding to eyewear display 100 of FIG. 1) housing the display light monitoring and optical engine control system 300. The optical engine 302 emits the display light 320 in the general direction of the incoupler (not shown) of the waveguide. While shown as being on a common substrate 350 in FIG. 3, in other embodiments, the optical engine 302 and the sensor 304 are positioned on different substrates or carriers.

The light conversion component layer 310, in the embodiment shown in FIG. 3, is implemented as a cover sheet or film arranged over the optical engine 302. That is, the light conversion component layer is positioned in the optical path of the display light 320 emitted from the optical engine 302. The light conversion component layer 310 is an optically transparent material such a glass sheet, a plastic layer, a polymer-based film, or the like, that allows a first portion 322 of the display light 320 emitted from the optical engine 302 to pass through. The light conversion component layer 310 includes light conversion components 312 (only one labeled for clarity purposes) integrated therein. The light conversion components 312 are sparsely spread out in the light conversion component layer 310. In some embodiments, the light conversion components 312 are quantum dots or phosphors that absorb light having the specific wavelength range corresponding to the display light 320 and convert it to light having another wavelength 322 (only one labeled for clarity purposes) illustrated as dashed lines. An example of a phosphor that can be used as the light conversion components 312 is an infrared (IR) phosphor that downconverts light in the visible spectrum to IR light. In some embodiments, the IR phosphor is doped with one or more of Ce, Cr, Yb, Ho, Pr, ER, or any combination thereof. An example of a quantum dot that can be used as the light conversion components 312 is a colloidal Lead Sulfide (PbS) quantum dot. The light conversion components 312 absorb a second portion of the RGB light in the display light 320 and convert it to light 322 outside of the visible light spectrum such as IR light. In some embodiments, the light conversion components 312 includes three types of light conversion components that each convert one of the three wavelengths of RGB light emitted from the optical engine. The amount of light in the first portion of light 322 that passes through the light conversion component layer 310 is substantially higher than the amount of converted light 324 in the second portion. For example, 90% or more of the display light 320 emitted from the optical engine 302 passes through the light conversion component layer 310 in first portion of light 322 whereas 10% or less of the display light 320 emitted from the optical engine 302 is absorbed by the light conversion components 312 in the light conversion component layer 310 and converted to the second portion of light 324. In some cases, 98% or more of the display light passes through as the first portion of light 322 and 2% or less of the display light is converted to the second portion of light 324. Thus, the light conversion component layer 310 has an imperceptible or nearly imperceptible effect on the amount of display light that is eventually delivered to the user. The amount of converted light 324 in the second portion is proportional to the amount of display light 320 emitted from the optical engine and can be used to generate a feedback signal to control the emission of display light 320 from the optical engine 302. Furthermore, since the converted light 324 has a wavelength (e.g., longer wavelength such as IR light) that falls outside of the visible spectrum, it will not interfere with or degrade the display light parameters that are tuned to deliver the virtual image to the user.

The sensor 304 is configured to detect light in the specific wavelength range of the converted light 324. For example, in the case where the light conversion components 312 convert a second portion of the RGB light from the display light 320 to IR light, the sensor 304 is selected and designed to detect the specific wavelength of the IR light. Thus, in some embodiments, the sensor 304 is insensitive (i.e., does not detect) light having the wavelength(s) of the display light 320. Based on the detected light, the sensor 304 is configured to generate converted light data 330 to transmit to the controller 306. In some embodiments, the converted light data 330 is in the form of a digital signal.

The controller 306 includes components to receive the converted light data 330 and generate a control signal 332 based on the converted light data 330. For example, the controller 306 compares the converted light data 330 to a threshold value and, based on the comparison, determines whether to generate a control signal 332 to adjust the emission of display light 320 from the optical engine. To illustrate, if the controller 306 determines the converted light data 330 falls below an intensity threshold, the controller 306 generates a control signal 332 to control the optical engine 302 to increase the intensity or power of the emitted display light 318. In some embodiments, the controller 306 includes hardware (e.g., a digital signal processor, an application specific integrated circuit (ASIC), a field programmable gate array (FPGA), or the like), software retrievable from a memory and executable by a processor, or a combination thereof to execute the functions described herein.

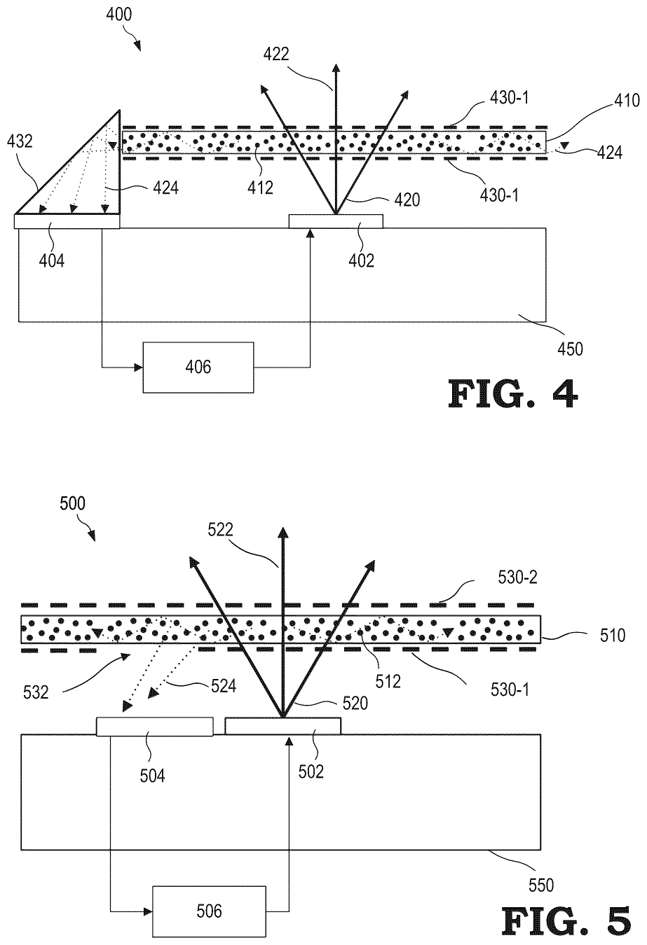

FIG. 4 illustrates an example display light monitoring and optical engine control system 400 in accordance with various embodiments. The display light monitoring and control system 400 includes an optical engine 402, a sensor 404, a controller 406, and a light conversion component layer 410. In some embodiments, the optical engine 402, the sensor 404, the controller 406, the light conversion component layer 410 with the plurality of light conversion components 412 (only one labeled for clarity purposes), and the substrate 450 are similar to the correspondingly named components described in the display light monitoring and optical engine control system 300 of FIG. 3. For example, the optical engine 402 is configured to emit display light 420 having one or more wavelengths of visible light (indicated by solid lines, only one labeled for clarity purposes) and the light conversion component layer 410 is configured to allow a first portion of the display light 422 to pass through unaffected while absorbing a second portion of display light and convert it to converted light 424 (indicated by dashed lines). In some embodiments, the display light monitoring and optical engine control system 400 shown in FIG. 4 is implemented in an eyewear display such as the eyewear display 100 of FIG. 1.

In some cases, the light conversion elements 412 in the light conversion component layer 410 emit the downconverted light 424 in a scattered form (e.g., in a Lambertian profile). Thus, in some embodiments, the display light monitoring and optical engine control system 400 includes one or more converted light directing components to direct a higher proportion of the converted light 424 to the sensor 404. In some embodiments, the one or more converted light directing components includes one or more filter layers 430-1, 430-2 on either side of the light conversion component layer 410. The filter layers 430-1, 430-2 reflect light in the wavelength range of the converted light 424 and transmit light having the one or more wavelengths of the display light 420 emitted from the optical engine 402. In this manner, the filter layers 430-1, 430-2 confine the converted light 424 to propagate towards the ends of the light conversion component layer 410 via TIR. For example, in the case that the converted light 424 is IR light, the filter layers 430-1, 430-2 reflect light in the IR wavelength range and transmit light in the visible light wavelength range. Thus, the first portion 422 of the display light 420 that is not converted to the converted light 424 can pass through. In some embodiments, the one or more converted light directing components includes a converted light router 432 positioned at one end of the light conversion component layer 410 to route the converted light 424 propagated to one end of the light conversion component layer 410 to the sensor 404. As illustrated in FIG. 4, in some embodiments, the converted light router 432 is a prism designed to route couple the converted light from the light conversion component layer 410 and direct the converted light 424 to the sensor 404. The converted light router 432 is thus designed with a particular geometry, prism materials, or prism coating(s) to receive light from the light conversion component layer 410 and reflect it, for example, towards the sensor 404. As such, the converted light directing components (the filter layers 430-1, 430-2, and the converted light router 432 in FIG. 4) direct a higher amount of the converted light 424 to the sensor 404. In some embodiments, this reduces the amount of display light 420 that needs to be converted to the converted light 424, thereby allowing a greater amount of light to pass through the light conversion component layer in the first portion 422.

Based on the converted light data generated by the sensor 404, the controller 406 generates a control signal to increase or decrease the intensity of the display light 420 emitted by the optical engine 402.

FIG. 5 illustrates an example display light monitoring and optical engine control system 500 in accordance with various embodiments. The display light monitoring and control system 500 includes an optical engine 502, a sensor 504, a controller 506, and a light conversion component layer 510. In some embodiments, the optical engine 502, the sensor 504, the controller 506, the light conversion component layer 510 with the plurality of light conversion components 512 (only one labeled for clarity purposes), and the substrate 550 are similar to the correspondingly named components described in the display light monitoring and optical engine control system 300 of FIG. 3 or the display light monitoring and optical engine control system 400 of FIG. 4. For example, the optical engine 502 is configured to emit display light 520 having one or more wavelengths of visible light (indicated by solid lines, only one labeled for clarity purposes) and the light conversion component layer 510 is configured to allow a first portion of the display light 522 to pass through unaffected while absorbing a second portion of display light and convert it to converted light 524 (indicated by dashed lines). In some embodiments, the display light monitoring and optical engine control system 500 shown in FIG. 5 is implemented in an eyewear display such as the eyewear display 100 of FIG. 1.

In some cases, the light conversion elements 512 in the light conversion component layer 510 emit the converted light 524 in a scattered form (e.g., in a Lambertian profile). To increase the amount of downconverted light 524 directed to the sensor 502, in some embodiments, the display light monitoring and optical engine control system 500 includes one or more converted light directing components. In some embodiments, the one or more converted light directing components includes one or more filter layers 530-1, 530-2 on either side of the light conversion component layer 510. The filter layers 530-1, 530-2 reflect light in the wavelength range of the converted light 524 and transmit light having the one or more wavelengths of the display light 520 emitted from the optical engine 502. In this manner, the filter layers 530-1, 530-2 confine the converted light 524 to propagate towards the ends of the light conversion component layer 510 via TIR. For example, in the case that the converted light 524 is IR light, the filter layers 530-1, 530-2 reflect light in the IR wavelength range and transmit light in the visible light wavelength range. In this manner, the first portion 522 of the display light 520 that is not converted to the converted light 524 can pass through. In some embodiments, the filter layer 530-1 facing the sensor 504 has an opening or hole 532 aligned with the sensor 504. Thus, the converted light 524 passes through the opening or hole 532 in the filter layer 530-1 to the sensor 504. In some embodiments, the positioning and the size of the opening or hole 532 in the filter layer 530-1 is selected to increase the amount of converted light 524 directed toward the sensor 504. As such, the converted light directing components (the filter layers 530-1, 530-2, and the opening or hole 532 in FIG. 5) direct a higher amount of the converted light 524 to the sensor 504. In some embodiments, this reduces the amount of display light 520 that needs to be converted to the converted light 524, thereby allowing a greater amount of light to pass through the light conversion component layer in the first portion 522.

Based on the converted light data generated by the sensor 504, the controller 506 generates a control signal to increase or decrease the intensity of the display light 520 emitted by the optical engine 502.

FIG. 6 illustrates an example display light monitoring and optical engine control system 600 in accordance with various embodiments. The display light monitoring and control system 600 includes an optical engine 602, a sensor 604, a controller 606, and a light conversion component layer 610. In some embodiments, the optical engine 602, the sensor 604, the controller 606, the light conversion component layer 610 with the plurality of light conversion components 612 (only one labeled for clarity purposes), and the substrate 650 are similar to the correspondingly named components described in the display light monitoring and optical engine control system 300 of FIG. 3, the display light monitoring and optical engine control system 400 of FIG. 4, or the display light monitoring and optical engine control system 500 of FIG. 5. For example, the optical engine 602 is configured to emit display light 620 having one or more wavelengths of visible light (indicated by solid lines, only one labeled for clarity purposes) and the light conversion component layer 610 is configured to allow a first portion of the display light 622 to pass through unaffected while absorbing a second portion of display light and convert it to converted light 624 (indicated by dashed lines). In some embodiments, the display light monitoring and optical engine control system 600 shown in FIG. 6 is implemented in an eyewear display such as the eyewear display 100 of FIG. 1.

In some cases, the light conversion elements 612 in the light conversion component layer 610 emit the downconverted light 624 in a scattered form such as a Lambertian profile. In some embodiments, the display light monitoring and optical engine control system 600 includes one or more converted light directing components to direct a higher amount of the converted light 624 to the sensor 604. In some embodiments, the one or more converted light directing components includes one or more filter layers 630-1, 630-2 on either side of the light conversion component layer 610. The filter layers 630-1, 630-2 reflect light in the wavelength range of the converted light 624 and transmit light having the one or more wavelengths of the display light 620 emitted from the optical engine 602. In this manner, the filter layers 630-1, 630-2 confine the converted light 624 to propagate towards within the light conversion component layer 610 via TIR. For example, in the case that the converted light 624 is IR light, the filter layers 630-1, 630-2 reflect light in the IR wavelength range and transmit light in the visible light wavelength range. The first portion 622 of the display light 620 that is not converted to the converted light 624 can pass through the filter layer 630-2. In some embodiments, the one or more converted light directing components includes an adhesive bridge 632 coupling the bottom filter layer 630-1 to the sensor 604. The adhesive bridge 632 has a refractive index different than air to couple the converted light 624 out of the light conversion component layer 610 and through the bottom filter layer 630-1 to the sensor 604. The adhesive bridge 632 is thus designed with a particular material or combination of materials to couple the converted light 624 out of the light conversion component layer 610 through the filter layer 630-1 and direct the converted light 624 towards the sensor 404. As such, the converted light directing components (the filter layers 630-1, 630-2, and the adhesive bridge 632 in FIG. 6) direct a higher amount of the converted light 624 to the sensor 604. In some embodiments, this reduces the amount of display light 620 that needs to be converted to the converted light 624, thereby allowing a higher amount of light to pass through the light conversion component layer in the first portion 622.

Based on the converted light data generated by the sensor 604, the controller 606 generates a control signal to increase or decrease the intensity of the display light 620 emitted by the optical engine 602.

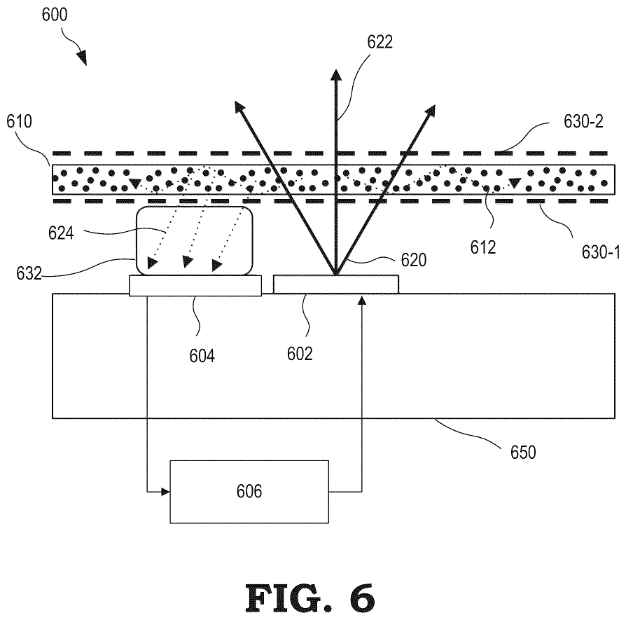

FIG. 7 illustrates an example of a display light and alignment monitoring optical engine control system 700 in accordance with various embodiments. That is, in addition to monitoring the intensity of the display light 720 emitted from the optical engine 702 as described above, the display light and alignment monitoring optical engine control system 700 also monitors the alignment of different components in an eyewear display such as in eyewear display 100 of FIG. 1. The display light and alignment monitoring optical engine control system 700 includes an optical engine 702, a sensor 704, a controller 706, and a light conversion component layer 710. In some embodiments, the optical engine 702, the sensor 704, the controller 706, the light conversion component layer 710 with the plurality of light conversion components (not labeled in FIG. 7 for clarity purposes), and the substrate 750 are similar to the correspondingly named components described in the systems described in FIGS. 3-6. For example, the optical engine 702 is configured to emit display light 720 having one or more wavelengths of visible light (indicated by solid lines, only one labeled for clarity purposes) and the light conversion component layer 710 is configured to allow a first portion of the display light 722 to pass through unaffected while absorbing a second portion of display light and convert it to converted light 724 (indicated by dashed lines).

The display light and alignment monitoring optical engine control system 700 includes a first filter layer 730 with an opening 732 to allow converted light 724-1 to pass through the filter layer 730 to the sensor 704. However, in the embodiment shown in FIG. 7, the other side of the light conversion component layer 710 (the side facing away from the optical engine 702) does not have a filter layer applied to it. Instead, the other filter layer 740 is applied to a downstream optical component. In the embodiment illustrated in FIG. 7, the other filter layer 740 is applied to the waveguide 742. The other filter layer 740 allows the display light 722 to pass through to the waveguide 742 and reflects the converted light 724-2 that propagated toward the downstream optical component back toward the sensor 704. The sensor 704 is able to detect the converted light 724-2 that reflects off of the downstream optical component and differentiate it from the converted light 724-1 received directly from the light conversion component layer 710. For example, the sensor 704 distinguishes between converted light 724-1 and 724-2 based on a difference in time or a difference in the angle of arrival between receiving converted light 724-1 and converted light 724-2. Thus, by detecting the converted light 724-2 that reflects off of the downstream optical component (i.e., waveguide 742 in this example), the sensor 704 is able to generate converted light data that the controller 706 can use to determine the alignment of the components in the system. For example, based on the converted light data generated by the sensor 704, the controller 706 can determine that the waveguide 742 has shifted a certain distance (e.g., in the scale of micrometers or millimeters) and send a control signal to the optical engine 702 to adjust the direction of the emission of the display light 720 accordingly.

In FIGS. 3-7, the display light monitoring optical control systems are shown as including one sensor for clarity purposes. In some embodiments, the systems include a number of sensors or an array of sensors that detect the converted light and generate the converted light data for transmission to the controller. Thus, in the embodiments including multiple sensors, the controller is configured to compile the converted light data received from the multiple sensors and generate the control signal for the optical engine based on the compilation of the converted light data. For example, the controller is configured to compile the converted light data based on the position of each sensor and the respective converted light data transmitted to the controller by each sensor.

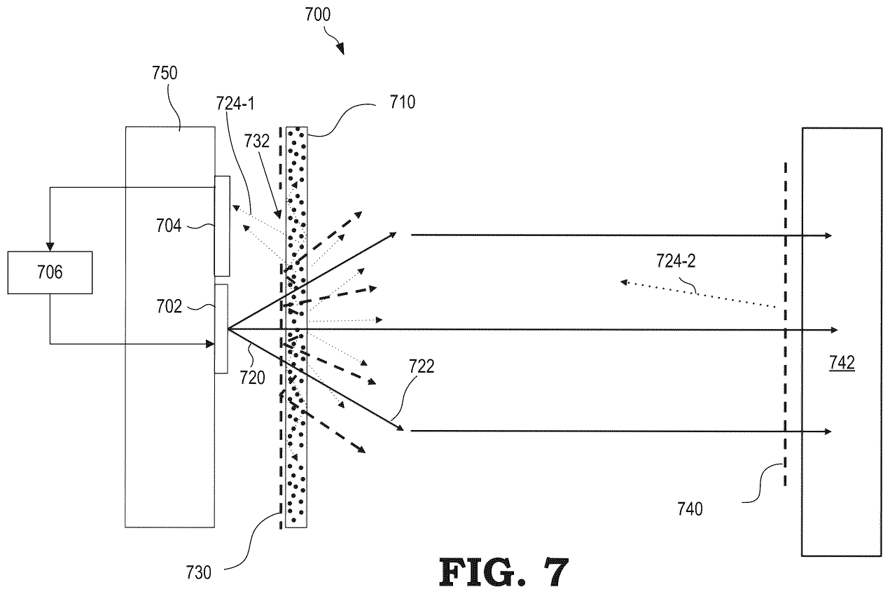

FIGS. 8 and 9 illustrate a microLED display with different examples of patterns of light conversion components 800 and 900, respectively, in accordance with various embodiments. The microLED display may correspond with the optical engine illustrated and described in the previous figures and the light conversion components may correspond with the light conversion components in the light conversion component layer illustrated and described in the previous figures. For example, in some embodiments, the light conversion components illustrated in FIGS. 8 and 9 are incorporated into a cover glass or sheet arranged between the microLED display and the waveguide.

In FIG. 8, the microLED display includes a plurality of microLEDs 802 (only one labeled for clarity purposes) arranged in an array on a substrate 850. In the illustrated embodiment, the microLED array includes an array of 7×7 microLEDs. In other embodiments, other numbers of microLEDs are included (i.e., more or less than 49 microLEDs). A plurality of sensors 804 (only one labeled for clarity purposes) are arranged around the microLED array on the substrate 850. In the illustrated embodiment, 13 sensors are depicted, but in other embodiments, the number of sensors can vary (i.e., more or less than 13 sensors). Five clusters of light conversion elements 812 (only one labeled for clarity purposes) are arranged over the microLED array: one cluster over each corner of the array and one cluster over the middle of the array. By placing the light conversion elements in a specific pattern such as one shown in FIG. 8, the converted light generated by the clusters of light conversion elements 812 forms specific patterns that the sensors 804 and controller (not shown) can use for alignment monitoring and controlling the direction of display light emitted by the microLED display. For example, in some embodiments, an expected converted light pattern is stored in a memory accessible by the controller. The controller compares the converted light data generated by the sensors 804 and compares it to the expected converted light pattern. If the controller determines that there is a mismatch between the two (e.g., the converted light pattern indicates a shift in one or more directions), the controller can then generate a signal to control the microLED to compensate for this mismatch and emit display light in a different direction.

Similarly, in FIG. 9, the microLED display includes a plurality of microLEDs 902 (only one labeled for clarity purposes) arranged in an array on a substrate 950. In the illustrated embodiment, the microLED array includes an array of 7×7 microLEDs. In other embodiments, other numbers of microLEDs are included (i.e., more or less than 49 microLEDs). A plurality of sensors 904 (only one labeled for clarity purposes) are arranged around the microLED array on the substrate 950. In the illustrated embodiment, 13 sensors are depicted, but in other embodiments, the number of sensors can vary (i.e., more or less than 13 sensors). Two elongated clusters of light conversion elements 912 (only one labeled for clarity purposes) are arranged over the microLED array: one cluster arranged over each side of the microLED array. By placing the light conversion elements in a specific pattern such as one shown in FIG. 9, the converted light generated by the clusters of light conversion elements 912 forms specific patterns that the sensors 904 and controller (not shown) can use for alignment monitoring and controlling the direction of display light emitted by the microLED display similar to that described above with respect to FIG. 8.

FIGS. 8 and 9 show examples of patterns of light conversion elements (i.e., clusters 812 in FIG. 8 and clusters 912 in FIG. 9) according to some embodiments. In other embodiments, the patterns of light conversion elements are different than those depicted in FIGS. 8 and 9.

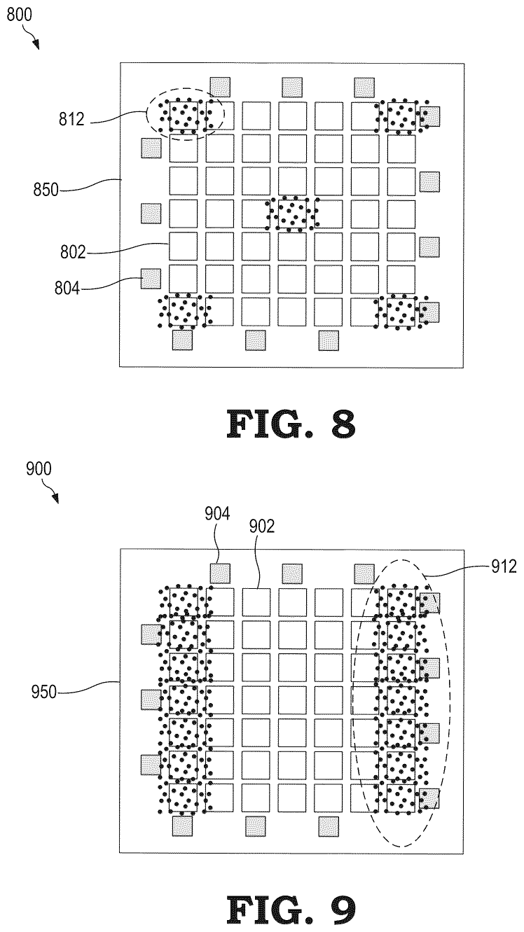

FIG. 10 shows an example incoupler configuration 1000 with filter layers 1004-1, 1004-2 applied to the sides of an incoupler 1002 to provide alignment monitoring, in accordance with various embodiments. In FIG. 10, the light emitted from the optical engine (not shown) through the light conversion components (not shown) is traveling into the page to be incident on the incoupler 1002. The filter layers 1004-1, 1004-2 thus border the incoupler 1002 and reflect the light converted by the light conversion components back to the sensor so that the sensor can detect the position of the incoupler 1002 and forward the incoupler's detected position to the controller for alignment monitoring purposes. That is, based on the detected position of the incoupler 1002, the controller controls the optical engine to alter the direction of the emitted display light so that it is aligned to be incident on the incoupler 1002.

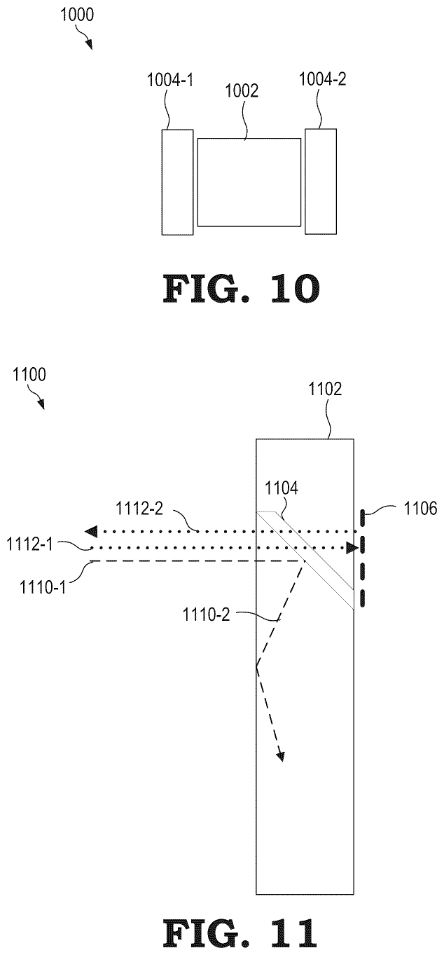

FIG. 11 shows an example incoupler configuration 1100 with a filter layer 1106 applied to a side of a waveguide 1102 and aligned with the incoupler 1104 to provide alignment monitoring, in accordance with various embodiments.

In some embodiments, the incoupler 1104 is implemented into the waveguide 1102 as a diffractive grating or a reflective facet. The incoupler 1104 is designed to reflect light having one or more wavelengths corresponding to the display light 1110-1 emitted from the optical engine (not shown). For example, the incoupler 1104 reflects one or more wavelengths corresponding to the RGB display light emitted from the optical engine and incouples this light into the waveguide as incoupled light 1110-2. Incoupler light 1110-2 propagates in the waveguide 1102 through one or more instances of TIR toward the outcoupler (not shown) to be ejected from the waveguide 1102 over an FOV area (such as one corresponding to FOV area 106 of FIG. 1). In addition to being configured to incouple the display light 1110-1 emitted from the optical engine, the incoupler 1104 is configured to transmit the converted light 1112-1 that is generated by the light conversion components in the light conversion component layer (not shown in FIG. 11). As such, the converted light 1112-1 passed through the incoupler 1104 and reflects off of the filter layer 1106 as reflected converted light 1112-2. On the return path, the reflected converted light 1112-2 passes through the incoupler 1104 once more to be detected by one or more sensor (not shown in FIG. 11) such as any of the sensors illustrated in the previous figures. By positioning the filter layer 1106 to coincide with the incoupler 1104, the positioning of the incoupler 1104 with respect to the light emitted from the optical engine can be monitored. Any detected shifts in the reflected converted light 1112-2 detected by the sensor can be used by the controller to modify the direction of the emitted display light 1110-1 so that it is properly aligned with the incoupler 1104.

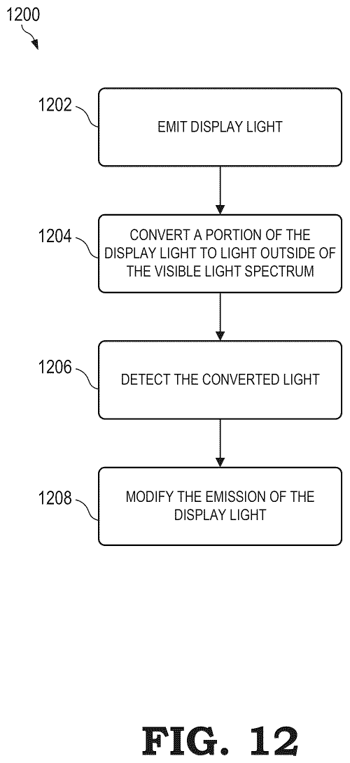

FIG. 12 shows an example flowchart 1200 describing a method flow for monitoring the intensity or alignment of display light emitted from an optical engine in an eyewear display in accordance with various embodiments.

At 1202, the method includes emitting display light from the optical engine. In some embodiments, this includes a microLED display emitting light having one or more wavelengths in the visible spectrum (e.g., RGB light).

At 1204, the method includes converting a portion of the display light to light outside of the visible light spectrum. In some embodiments, this includes a light conversion component layer positioned between the optical engine and a waveguide converting a relatively small portion of the display light to infrared (IR) or near-IR light, for example. Furthermore, a larger portion of the display light passes through the light conversion layer towards an incoupler of the waveguide. For example, the amount of light that is converted is in the range of 10% or less of the light emitted from the optical engine.

At 1206, the method includes detecting the converted light by a sensor with a detection sensitivity in the wavelength range of the converted light. For example, in the case that the converted light is IR light, the sensor is an IR sensor configured to detect IR light and not detect light having the wavelengths emitted from the optical engine.

At 1208, the method includes modifying the emission of display light based on the detected converted light. In some embodiments, this includes the sensor generating converted light data and transmitting it to a controller. Based on the converted light data, the controller determines whether to modify the intensity or the direction of the display light emitted from the optical engine.

In some embodiments, the techniques described herein can be utilized for eye-tracking techniques in an eyewear display such as eyewear display 100 of FIG. 1. For example, the converted light produced by the light conversion components can be used for illumination purposes in eye-tracking mechanisms.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An eyewear display comprising:
an optical engine to emit display light having one or more wavelengths;
a waveguide to incouple a first portion of the display light, the first portion of the display light comprising light having the one or more wavelengths; and
a plurality of light conversion components positioned between the optical engine and the waveguide, the plurality of light conversion components to convert a second portion of the display light to converted light having higher wavelengths than the display light.

2. The eyewear display of claim 1, further comprising:
one or more sensors configured to detect the converted light to generate converted light data.

3. The eyewear display of claim 2, further comprising one or more filter layers to transmit the one or more wavelengths of display light emitted from the optical engine and reflect the converted light.

4. The eyewear display of claim 3, wherein the one or more filter layers direct the converted light to the one or more sensors.

5. The eyewear display of claim 3, wherein the one or more filter layers comprise an opening aligned with a corresponding position of the one or more sensors.

6. The eyewear display of claim 3, further comprising an adhesive bridge between the one or more filter layers and the one or more sensors, the adhesive bridge having a refractive index to couple the converted light from one side of the one or more filter layers to the one or more sensors.

7. The eyewear display of claim 2, further comprising:
a controller to receive the converted light data and generate a control signal for the optical engine based on the received converted light data.

8. The eyewear display of claim 7, wherein the control signal controls the optical engine to modify an intensity or a direction of the emitted display light.

9. The eyewear display of claim 7, wherein the plurality of light conversion components is positioned in a pattern between the optical engine and the waveguide to generate a converted light pattern.

10. The eyewear display of claim 9, wherein the one or more sensors detect the converted light pattern and generates light pattern data.

11. The eyewear display of claim 10, the controller to receive the light pattern data and generate an alignment signal based on comparing the light pattern data to an expected light pattern.

12. The eyewear display of claim 11, wherein the alignment signal controls the optical engine to emit the display light in a different direction.

13. The eyewear display of claim 1, wherein the plurality of light conversion components comprises one or more phosphors, one or more quantum dots, or a combination thereof.

14. An image projection system comprising:
an optical engine to emit display light having one or more wavelengths;
a waveguide to incouple a first portion of the display light, the first portion of the display light comprising light having the one or more wavelengths; and
a plurality of light conversion components positioned between the optical engine and the waveguide, the plurality of light conversion components to convert a second portion of the display light to converted light having higher wavelengths than the display light.

15. The image projection system of claim 14, further comprising:
one or more sensors configured to detect the converted light to generate converted light data.

16. The image projection system of claim 15, further comprising:
a controller to receive the converted light data and generate a control signal for the optical engine based on the received converted light data.

17. A method comprising:
emitting, by an optical engine, display light having one or more wavelengths;
incoupling, at a waveguide, a first portion of the display light, the first portion of the display light comprising light having the one or more wavelengths;
converting, by a plurality of light conversion components positioned between the optical engine and the waveguide, a second portion of the display light to converted light having higher wavelengths than the display light; and
detecting, by one or more sensors, the converted light.

18. The method of claim 17, further comprising:
generating converted light data based on the detected converted light.

19. The method of claim 18, further comprising:
generating, based on the converted light data, a control signal to control one or more parameters of the display light emitted by the optical engine.

20. The method of claim 19, wherein the one or more parameters comprise an intensity of the display light emitted by the optical engine or a direction of the display light emitted by the optical engine.
